(19) United States
(12) Patent Application Publication
(10) Pub. No.: US 2007/0220809 A1
(43) Pub. Date: Sep. 27, 2007

(54) Flower pot and method

(76) Inventor: Ron Serio, Buffalo, NY (US)

Correspondence Address: HODGSON RUSS LLP;THE GUARANTY BUILDING, 140 PEARL STREET, SUITE 100, BUFFALO, NY, 14202-4040, US

(21) Appl. No.: 11/726,580

(22) Filed: Mar. 22, 2007

Related U.S. Application Data
(60) Provisional application No. 60/785,222, filed on Mar. 23, 2006.

(51) Int. Cl. A01G 9/02

(52) U.S. Cl. 47/66.6

(57) ABSTRACT

A pot comprising a surrounding wall having a curved portion joined to a flat portion and the surrounding wall has a rim that defines an opening. A base having a flat base portion joined to an end of the surrounding wall opposite the rim. An internal post support structure joined to the flat base portion that extends in a direction toward the rim and having a rectangular cross section. A circular cross section pot having an internal post structure. A ground flower pot comprising a ground base, a lawn wall and an opposed garden wall joined to the base. A flower pot link segment comprising a link base, a lawn wall, an opposed garden wall joined to the base, with a first tube joined proximal a first end of the link base and a second tube of lesser diameter joined proximal the second end of the link base.

### CROSS REFERENCE TO RELATED APPLICATIONS

This application claims priority to U.S. Provisional Patent Application No. 60/785,222, filed Mar. 23, 2006, to Serio and entitled “Flower Pot and Method,” the disclose of which is hereby incorporated by reference.

### FIELD OF THE INVENTION

The present invention relates to the field of pots and flower pots and the use of flower pots in landscaping.

### BACKGROUND

Flower pots have been made and used in the past to hold flowers and plants. The typical flower pot is made of plastic or clay and has a truncated conical shape such that the opening in the pot is opposite the base of the pot, and the opening in the pot has a greater diameter than the base of the pot. Some flower pots are in the shape of a right cylinder. The base of the pot typical has at least one drain opening so that excess water can flow out of the flower pot.

There are also hanging flower pots that are equipped with a wire arrangement that extends from the rim of the pot. The one end of the wires are joined to the flower pot and the other end of the wires meet at a hook, such that the flower pot can be hooked to structures and thus be supported above ground level.

There are limitations with flow pots, for example, if they are hung against a flat wall the curvature of the flower pot causes the flower pot to twist and rotate when the wind blows or when the plant is watered. In addition, when flower pots are placed on the ground they can be visually unappealing in that the pot is visible which detracts from, for example, the natural beauty of a flower garden. In addition, when set on the ground the flower pot has a tendency to tip, because the top of the flower pot is wider than the base of the flower pot and because the flower pot is top heavy due to the load of the plant at the top of the pot.

Thus, what is needed is a better flower pot and plant support system the overcomes these problems.

### SUMMARY

A flower pot and method includes a flower pot having a surrounding wall. The surrounding wall has a curved portion that is joined to a flat portion, and the curved portion and flat portion are joined to a base. The curved portion can have a truncated conical shape or the curved portion can have a right cylinder shape. A rim surrounds an opening in the pot. The base also has a base flat portion with flow openings for allowing excess water to flow out of the flower pot. An internal post support structure extends from the flat portion of the base into the interior of the pot and in a direction toward the rim of the pot. The internal post support structure includes internal walls that define a post recess for receiving a post, and the internal post structure has a generally rectangular cross section. The pot can be advantageously positioned and supported on a fence post when the post recess is aligned with the post and the pot is moved onto the fence post. The flat portion of the pot is adjacent a fence that is supported by the fence post after the pot has been positioned on the fence post. Thus, the pot is advantageously releaseably positioned on the fence post and the wind cannot rotate the pot or tip the pot on its side. The block and post recess can be in a close fitting relationship to prevent the block from wobbling. In addition, no curved portion of the pot abuts against any flat surface, for example a fence, and this advantageously eliminates the possibility of the pot undesirably rotating. In another embodiment, the pot can have connector openings in the flat portion, such that a connector member can be positioned in the connector openings. The connector member is looped over a post and the connector member supports the pot on the post.

In a second embodiment, there is a load support member having a lateral support. The load support member is for use with a block having a block recess. The load support member is supported in the ground and the block is positioned over the load support member, such that a portion of the load support member is positioned internal to the block recess, thus releasably joining the block and load support member. The block is supported on the lateral support extending from the load member. The pot has a circular cross section and is aligned with the block an moved onto the block, such that the block is positioned in the post recess in the pot. The pot is thereafter advantageously releasably joined to the load support member and is prevented from tipping or twisting. The block and post recess can be in a close fitting relationship to prevent the pot from wobbling.

In a third embodiment the pot is the same as the second embodiment, except there is an there is an internal support body joined to the flat base portion which extends in a direction toward a second end or rim of the pot instead of the internal post support structure. The internal support body has a tubular wall that is joined to the flat base portion, and defines a load support opening in the flat base portion of the pot that leads to a load support recess defined by the tubular wall and an end wall. The load member is received in the internal support body and supported by the load member. The load member and internal support body are in a close fitting relationship to prevent the pot from wobbling.

There is also provided a ground flower pot system. In a first embodiment, there is a ground flower pot or ground pot having a ground base. The ground flower pot also has a lawn wall, and an opposed garden wall that extend from the ground base. Opposed abutting walls extend from the lawn wall and the garden wall and are joined to the lawn and garden walls. The height of the abutting walls decreases in a direction toward the garden wall, such that the height of the garden wall is less than a height of the lawn wall. A soil recess is thus defined between the ground base, lawn wall, garden wall, and opposed side walls. Clamps are provided to clamp a line of the ground flower pots together. That the ground flower pots can be positioned around plants, flower gardens, sidewalks. Then, the soil recesses are filled with soil and plants are planted in the soil.

In another embodiment, there are flower pot segments or links that are linked to one another. Each link or link segment includes a link base, a first tube joined to a first end of the link base and a second tube joined to a second end of the link base. The diameter of the first tube is greater than the diameter of the second tube. The first and second tubes have a right cylinder shape. Each link or link segment further includes a lawn wall joined to the base and a garden wall joined to the link base, and the lawn and garden walls extend a distance less than a length of the link base. A soil recess is defined between the link base, the first tube, the second tube, and the lawn wall and the garden wall. The lawn wall has a greater height than the garden wall. To link the link segments, a first link segment is placed on the ground, and a second link segment is placed over the first link segment that is on the ground. The first tube of the second link segment is moved over the second tube of the first link segment, such the second tube of the first link segment is received in the greater diametered first tube of the second link segment. The linkable flower pot segments can be advantageously pivoted relative to one another and positioned around any garden, sidewalk, or plant. After positioning the linkable ground flower pots, the soil recesses are filled with soil and plants.

### BRIEF DESCRIPTION OF THE DRAWING FIGURES

It is pointed out that in the drawing figures like reference numbers have been used to call out the same elements, structures, surfaces and components throughout.

FIG. 1 is a top plan view of the pot supported on a fence post.

FIG. 2 front elevation of the pot supported on the fence post.

FIG. 3 is a sectional view taken along cut line A-A in FIG. 1 of the pot supported on a fence post.

FIG. 4 is a top plan view of the pot.

FIG. 5 is a front elevation view of the pot.

FIG. 6 is a sectional view of the pot taken along cut line B-B in FIG. 5.

FIG. 7 is a rear elevational view of a second embodiment of the pot supported on a vertical support member with a connector member.

FIG. 8 is a perspective view of a connector member.

FIG. 9 is a perspective view of a second embodiment of a connector member.

FIG. 10 is a top plan view of the second embodiment of the pot supported by the connector member and a vertical support member.

FIG. 11 is a front elevation view of a second embodiment of the pot.

FIG. 11A is a top plan view of the second embodiment of the pot.

FIG. 12 is an exploded view of a block and load member.

FIG. 13 is a sectional view of the assembled second embodiment of the pot and block member when supported on a load member taken along cut line C-C of FIG. 14.

FIG. 14 is a front elevational view of the second embodiment of a pot supported on a load member

FIG. 15 is a top plan view of the second embodiment of the pot supported on a curved load member.

FIG. 16 is a sectional view of the of the second embodiment supported on a curved load member taken along cut line D-D of FIG. 15.

FIG. 16A is a front elevational view of a third embodiment of the pot.

FIG. 16B is a top plan view of the third embodiment of the pot.

FIG. 16C is a sectional view of the third embodiment of the pot taken along cut line CC-CC of FIG. 16D.

FIG. 16D is a is a front elevational view of the third embodiment of the pot supported on a load member.

FIG. 16E is a top plan view of the third embodiment of the pot supported on a curved load member.

FIG. 16F is a sectional view of the third embodiment of the pot taken along cut line DD-DD of FIG. 16E.

FIG. 17 is a perspective view of ground flower pots joined with clamps.

FIG. 18 is a sectional view of a ground pot taken along cut line E-E of FIG. 19.

FIG. 19 is front elevational view of three connected ground pots.

FIG. 20 is a rear elevational view of three connected ground pots.

FIG. 20A is a plan view of differently shaped ground pots.

FIG. 20B is a plan view of the differently shaped ground pots positioned around a garden.

FIG. 21 is a top plan view of a link segment.

FIG. 22 is a sectional view of a link segment taken along cut line F-F of FIG. 21.

FIG. 22A is a rear elevational view of a link segment.

FIG. 23 is a front elevational view of two link segments linked together.

FIG. 24 is a top plan view of link segments that are linked together and are at angles relative to one another.

### DETAILED DESCRIPTION

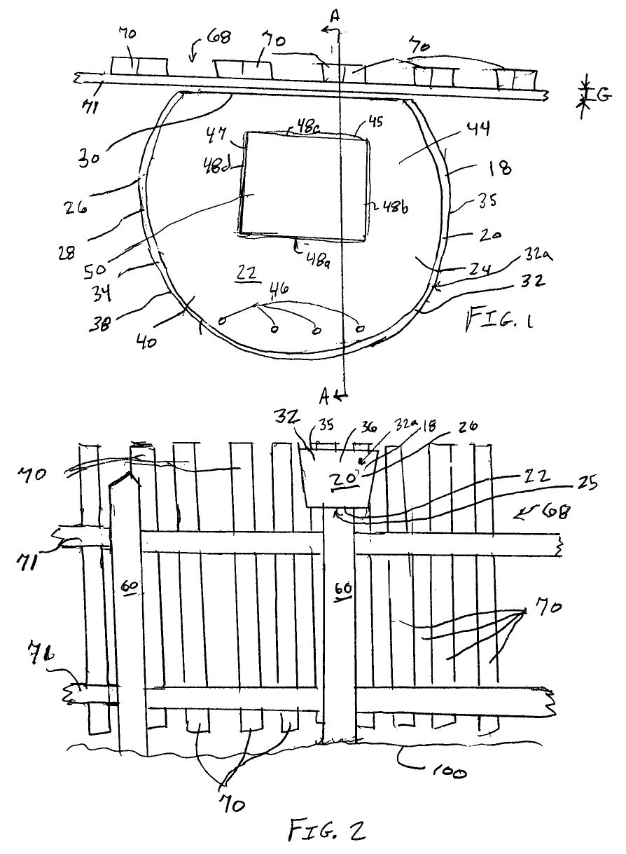

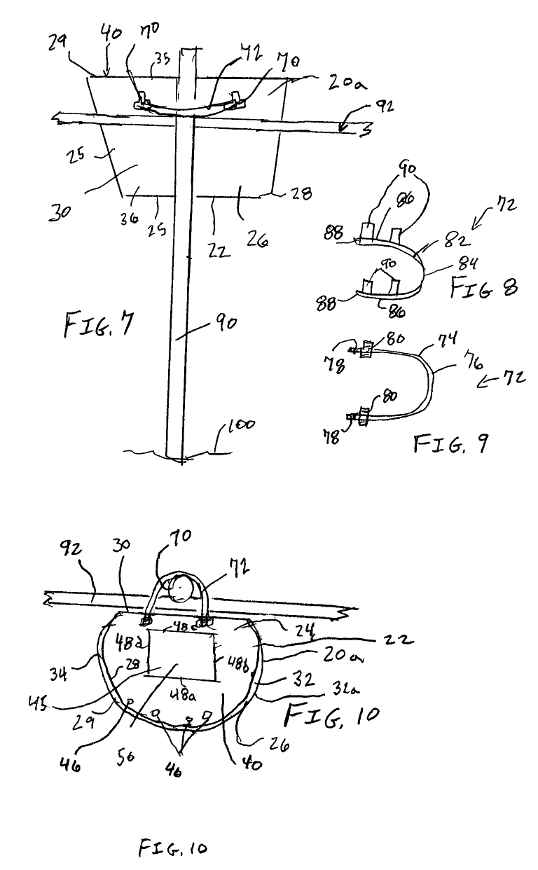

A housing 18 comprising a pot 20 (also referred to herein as flower pot 20) is shown in FIGS. 1-6. The flower pot 20 has a base 22 having interior and exterior surfaces 24, 25, respectively. There is a surrounding wall 26 having opposed first and second ends 28, 29, respectively, with the first end 28 is joined to the base 22 such that the surrounding wall 26 extends from the base 22. The surrounding wall 26 has a flat portion 30 that is joined to a curved portion 32, and each of the flat portion 30 and curved portion 32 is joined to the base 22, as shown in FIG. 1-4. The curved portion 32 can be embodied as to have a truncated conical shape as indicated by arrow 32a or a right cylinder shape, and the truncated conical shape is shown in FIGS. 1-4. The surrounding wall 26 has interior and exterior surfaces 34, 36. The second end 29 of the surrounding wall 26 has a rim 35 that defines an opening 38 that leads to a plant recess 40 in the pot 20, and the plant recess 40 is defined by the interior surface 24 of the base 22 and interior surface 34 of the surrounding wall 26. The plant recess 40 is for receiving a plant (not shown). The surrounding wall 26 and the base 22 can be one piece and made from plastics, molded plastics, clay, and other suitable materials, for example metals and wood, and combinations thereof. The surrounding wall 26 and base 22 can also be separate components and joined together. Molding plastics and clay is well known to those having ordinary skill in the art.

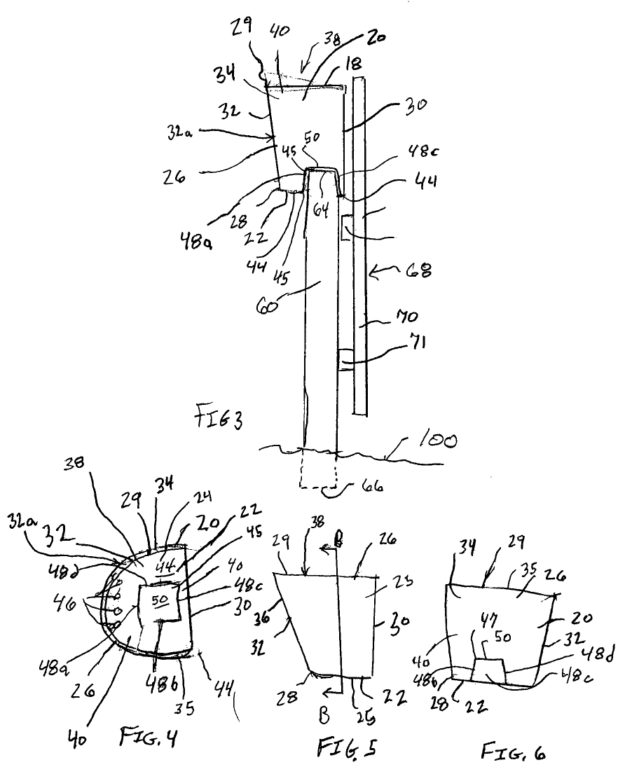

As previously mentioned, the surrounding wall 26 is joined to the base 22. The base 22 has a flat base portion 44 with flow openings 46 so that excess water can flow out of the pot 20 through the flow openings 46. As shown in FIGS. 1, 3, 4 and 6, extending from and joined to the flat base portion 44 is an internal post support structure 45 that includes first, second, third and fourth internal walls 48a, 48b, 48c and 48d, respectively, each of which extends in a direction toward the second end 30 of the surrounding wall 26. The first, second, third and fourth internal walls 48a, 48b, 48c and 48d, respectively, are joined to one another. The first, second, third and fourth internal walls 48a, 48b, 48c and 48d, respectively, extend from the flat base portion 44 at an angle which can be less than a 90° angle as shown in FIG. 3, such that the first, second, third and fourth internal walls 48a, 48b, 48c and 48d, respectively, slope or taper inwardly. The angle could also be a 90° angle.

The internal post support structure 45 further includes a post wall 50 that is joined to each of the distal ends 47 of the first, second third and fourth internal walls 48a, 48b, 48c and 48d, respectively. The first, second, third and fourth internal walls 48a, 48b, 48c and 48d, respectively, define a post opening 52, and the post opening 52 leads to a post recess 54 that is defined by the first, second third and fourth internal walls 48a, 48b, 48c and 48d, respectively, and the post wall 50. The post recess 54 extends into the flat base portion 44 of the base 22. The post recess 52 has a rectangular cross section and the recess narrows in a direction toward the post wall 50 because the first, second third and fourth internal walls 48a, 48b, 48c and 48d, respectively, slope inwardly. In another embodiment wherein the first, second third and fourth internal walls 48a, 48b, 48c and 48d, respectively, are not sloped, the post recess does not narrow. As shown in FIGS. 1 and 3, the internal post support structure is proximal the flat portion 30 of the surrounding wall 26.

To use, as shown in FIG. 3, the post recess 54 is sized such that it can be positioned on a fence post 60. In particular, the fence post 60 has a fence post first end 64 and an opposed fence post base 66 as shown in FIG. 3, and the fence post base 66 is supported in the ground 100 or other supporting material. There is a fence 68 having vertical slats 70 and horizontal members 71 that connect the slats 70. The fence post 60 is connected to the horizontal members 71 thus supporting the fence 68. The flower pot 20 is moved into alignment with the fence post 60, such that the post recess 54 is positioned over the fence post first end 64, and the flat portion 30 of the surrounding wall 26 faces the vertical slats 70. A gap space, designated G in FIG. 1, extends between the vertical slats 44 and the flat portion 26 of the flower pot 20. The pot 20 is moved in a direction toward the ground 100 until the post wall 50 abuts against the fence post first end 64. The pot 20 is thereafter supported on the fence post 60.

Thus, the flower pot 20 is advantageously supported proximal the fence 68, and cannot rotate or slide off the fence post 60 even when subjected to the forces of nature, for example wind. In addition, the flower pot 20 advantageously visually appealing when fitted on the fence post 60, which has the advantage of increasing consumer interest and purchases of the flower pot 20 and the plants.

The method of making the pot 20 includes providing the surrounding wall 26 with a flat portion 30 and curved portion 32 and joining the surrounding wall 26 to a base 22 having a flat base portion 44 with flow openings 46. The method includes providing the surrounding wall 26 with a rim 35 that defines an opening 38, and forming an internal post support structure 45 that extends in the direction towards the rim 35. The method includes forming the internal support structure 45 from first, second, third and fourth internal walls 48a, 48b, 48c and 48d, respectively, and joining them with one another to form a post recess 54 in the pot 20.

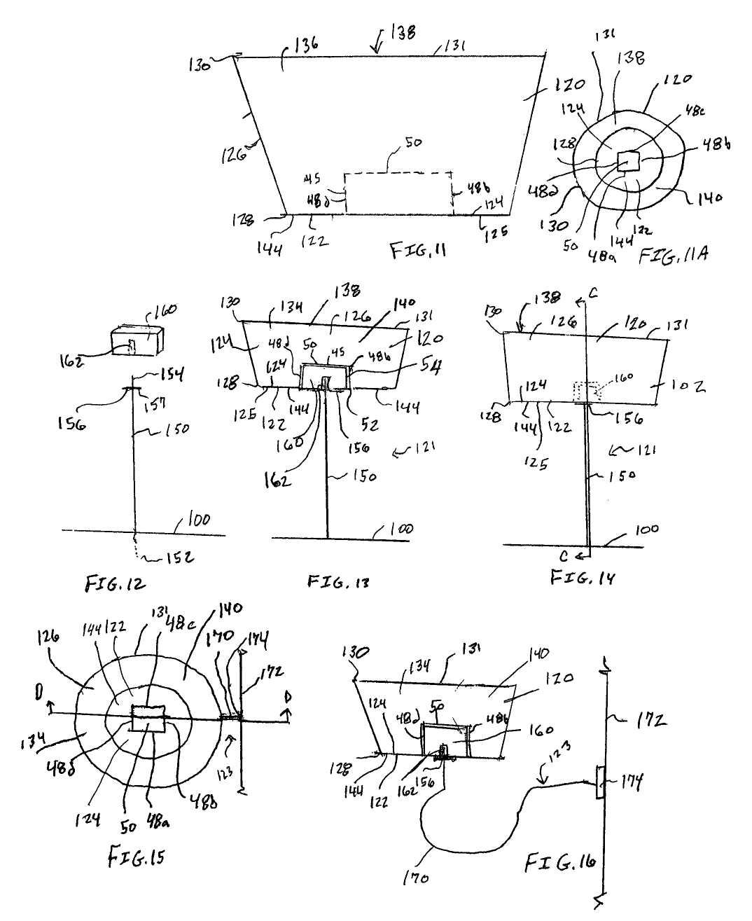

In another embodiment, the pot 20a is structurally the same as the pot described in connection with the first embodiment, except that the flat portion 30 of the surrounding wall 26 has connector openings 70, as shown in FIGS. 7-10. A connector member 72 is positioned in the connector openings 70. As shown in FIG. 9, the connector member 72 can be a U-bolt 74 having a curve 76 with threaded ends 78 to which nuts 80 are threaded. As shown in FIG. 8, the connector member 72 can also embodied as clip device 82 with a curved clip portion 84 that extends to straight portions 86 having clip ends 88. Engaging members 90 extend from the straight portions 86 proximal the clip ends 88.

To use the connector member 72, the connector member 72 is positioned in the connector openings 70 and fitted around a vertical support member 90 that is supported in the ground 100, as shown in FIGS. 7 and 10. The connector member 72 is slid in a direction toward the ground 100 until the connector member 72 contacts a horizontal support member 92. The horizontal support member 92 can be joined to the vertical support member 90 with a bolt, wire or other suitable means for connecting. The horizontal support member 92 thereafter supports the connector member 72, which in turn supports the pot 20a. One of the advantages of this embodiment is that the flower pot 20a is capable of being supported as described above or on a fence post 60 in the manner previously described. The method of making the pot 20a is the same as described in connection with the first embodiment, but also includes forming connector openings 70 in the flat portion 30 and providing a connector member 72 and positioning the connector in the connector openings 70.

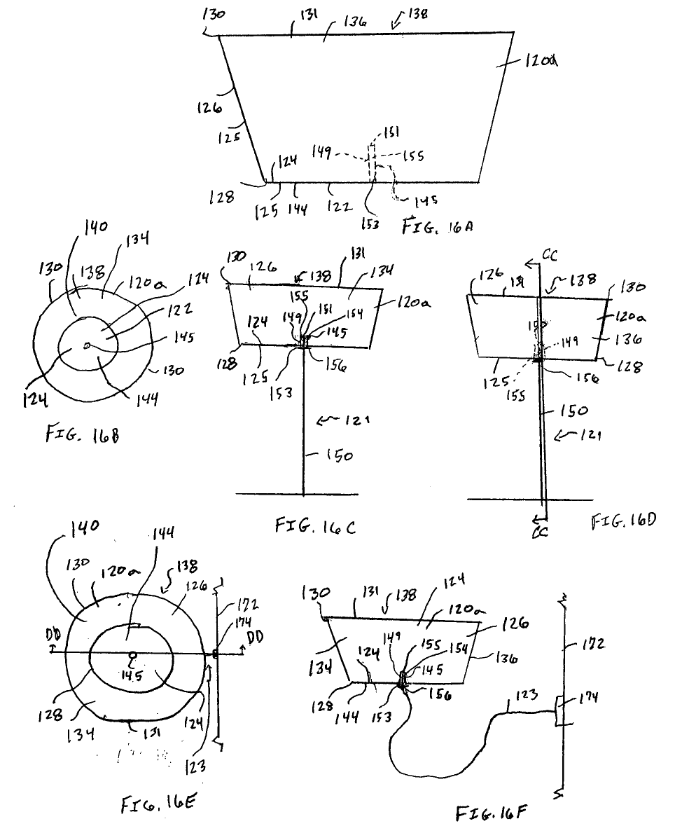

In a second embodiment shown in FIGS. 11-14 there is a circular cross section pot 120 (hereinafter referred to as pot 120) and a support assembly 121. As shown in FIGS. 11 and 11A, the pot 120 has a base 122 having interior and exterior surfaces 124, 125, respectively, and a flat base portion 144. There is a surrounding wall 126 having opposed first and second ends 128, 130, respectively, and the first end 128 is joined to the base 122 such that the surrounding wall 126 extends from the base 122. The second end 130 includes the rim 131 of the pot 120. The surrounding wall 126 has a truncated conical shape and is joined to the base 122, but in another embodiment can have a right cylinder shape. The surrounding wall 126 has interior and exterior surfaces 134, 136. As shown in FIG. 13, the second end 130 of the surrounding wall 126 defines an opening 138 that leads to a plant recess 140 in the pot 20, and the plant recess 140 is defined by the interior surface 124 of the base 122 and interior surface 134 of the surrounding wall 126. Each of the surrounding wall 126 and the base 122 has a circular cross section. The plant recess 140 is for receiving a plant (not shown). The surrounding wall 126 and the base 122 can be one piece and made from plastics, molded plastics, clay, wood, metal and other suitable materials and combinations thereof, but could comprise multiple components.

The remainder of the structure of the pot 120 is that same as the pot described in connection with the first embodiment, and accordingly like reference numbers have been used to identify these elements, components and surfaces. In particular, as shown in FIGS. 11A and 13 extending from and joined to the flat base portion 144 is an internal post support structure 45 that includes the first, second, third and fourth internal walls 48a, 48b, 48c and 48d, respectively, each of which extends in a direction toward the second end 130 of the surrounding wall 126. The first, second, third and fourth internal walls 48a, 48b, 48c and 48d, respectively, are joined to one another, and extend from the flat base portion 144 at an angle. The angle can be a 90° angle, or less than a 90° angle such that the first, second, third and fourth internal walls 48a, 48b, 48c and 48d, respectively, slope inwardly in a direction toward the second end 130.

The post wall 50 is joined each of the first, second third and fourth internal walls 48a, 48b, 48c and 48d, respectively. The first, second, third and fourth internal walls 48a, 48b, 48c and 48d, respectively, define a post opening 52, and the post opening 52 leads to a post recess 54 that is defined by the first, second third and fourth internal walls 48a, 48b, 48c and 48d, respectively, and the post wall 50. The post recess 54 extends into the flat base portion 44 of the base 122. The post recess 52 has a rectangular cross section and the recess narrows in a direction toward the post wall 50 because the first, second third and fourth internal walls 48a, 48b, 48c and 48d, respectively, slope inwardly. In another embodiment wherein the first, second third and fourth internal walls 48a, 48b, 48c and 48d, respectively, are not sloped, the post recess does not narrow. As shown in FIG. 11A, the internal post support structure 45 is centered, such that it extends from a center position of the flat base portion 144.

As shown in FIGS. 12-14, the support assembly 121 includes a load member 150 having a load member ground end 152 for insertion into the ground 100, and an opposed support end 154. There is a lateral support 156 that is joined, for example with a weld, to the load member 150 proximal the support end 154 thereof, as shown in FIG. 12. A block 160 (also referred to herein as an adapter 160) having a block recess 162 is positioned on the support end 154 of the load member 150 such that the load member 150 is positioned the block recess 162. The block 160 is supported on the lateral support 156. The block 160 is sized such that its dimensions are less than the dimensions of the post recess 54 in the pot. The block 160 comprises wood, rubber, plastic, elastic material, and combinations thereof and other suitable materials. It is pointed out that the block 160 can also comprise material that compresses around the support end 154 of the load member 150 which joins the block 160 and support end 154 of the load member 150.

To use, the load member 150 is supported in the ground 100, and the block 160 is positioned on the support end 154 of the load member 150 until it abuts against the lateral support 156. The lateral support 156 is a ring 157 welded to the load member 150. The pot 120 is positioned on the block 160 and thereafter supported by the load member 150. This embodiment has the advantages of allowing the pot 120 to be used in combination with a load member 150 that can have many different shapes and can have ornamental features (not shown).

To make the pot 120 and support assembly 121 the method includes providing a pot 120 having a base 122 and interior and exterior surfaces 124, 125, respectively, and a flat base portion 144. The method includes providing a surrounding wall 126 having opposed first and second ends 128, 130, respectively, with the first end 128 is joined to the base 122 such that the surrounding wall 126 extends from the base 122. The method includes providing the surrounding wall 126 has a truncated conical shape and joining it to the base 122. The method includes providing a load member 150 having a load member ground end 152 for insertion into the ground 100, and an opposed support end 154, and joining a lateral support 156 to the load member 150 proximal the support end 154 thereof. The method includes providing a block 160 having a block recess 162 and positioning the support end 154 of the load member 150 such that the load member 150 is positioned the block recess 162.

FIGS. 15 and 16 show an embodiment the same as shown in FIGS. 11-14, with the difference being in the that the pot 120 is supported on a curved load member 170 that is joined to vertical support body 172 with a mount 174. This advantageously allows the pot 120 to be supported on vertical support bodies 172, for example a wall or tree. The block 160 is the made and used in the same manner as in the embodiment described above. It is to be understood that the load member 150 and curved load member 170 can be iron, plastic, or wood, and can be ornamentally decorated, advantageously enhancing the appearance of the load member 150 and curved load member 170 to increase consumer interest and sales.

In a third embodiment shown in FIGS. 16A-16D there is a circular cross section pot 120a (also referred to herein as pot 120a) having a base 122 having interior and exterior surfaces 124, 125, respectively, and a flat base portion 144. The circular cross section pot 120a has a surrounding wall 126 having opposed first and second ends 128, 130, respectively, and the first end 128 is joined to the base 122 such that the surrounding wall 126 extends from the base 122. The second end 130 includes the rim 131 of the pot 120a. The surrounding wall 126 has a truncated conical shape and is joined to the base 122, but in another embodiment can have a right cylinder shape. The surrounding wall 126 has interior and exterior surfaces 134, 136. As shown in FIG. 13, the second end 130 of the surrounding wall 126 defines an opening 138 that leads to a plant recess 140 in the pot 120a, and the plant recess 140 is defined by the interior surface 124 of the base 122 and interior surface 134 of the surrounding wall 126. Each of the surrounding wall 126 and the base 122 has a circular cross section. In another embodiment, the surrounding wall 126 has a right cylinder shape. The plant recess 140 is for receiving a plant (not shown). The surrounding wall 126 and the base 122 can be one piece or separate components that are joined together, and made from plastics, molded plastics, clay, metal, wood and other suitable materials and combinations thereof, and can be separate pieces that are joined to one another.

As shown in FIGS. 16A-16D, an internal support body 145 is joined to the flat base portion 144 and extends in a direction toward the second end 130 of the pot 120a. The internal support body 145 has a tubular wall 149 that is joined to the flat base portion 144 at one end thereof, and that is joined to an end wall 151 at the other end thereof. The tubular wall 149 extends in a direction toward the second end 130 of the surrounding wall 126. In one embodiment, the tubular wall 149 has the shape of right cylinder. The internal support body 145 thus defines a load support opening 153 in the flat base portion 144 of the pot 120a, and the load support opening 153 leads to a load support recess 155 that is defined by the tubular wall 149 and the end wall 151. The load support recess 155 has a diameter that is sized to receive the support end 154 of the load support member 150 in, for example, a close fitting relationship. The load support member 150 is the same as described in connection with the second embodiment. Thus, when the pot 120a is moved onto the load support member 150, the lateral support 156 abuts against the flat base portion 144 thus supporting the pot 120a. As shown in FIG. 16B, the internal post support structure 45 is centered, such that it extends from a center position of the flat base portion 144. As shown in FIGS. 16E and 16F, the pot 120a is also supportable in the same manner on the previously described curved load member 170.

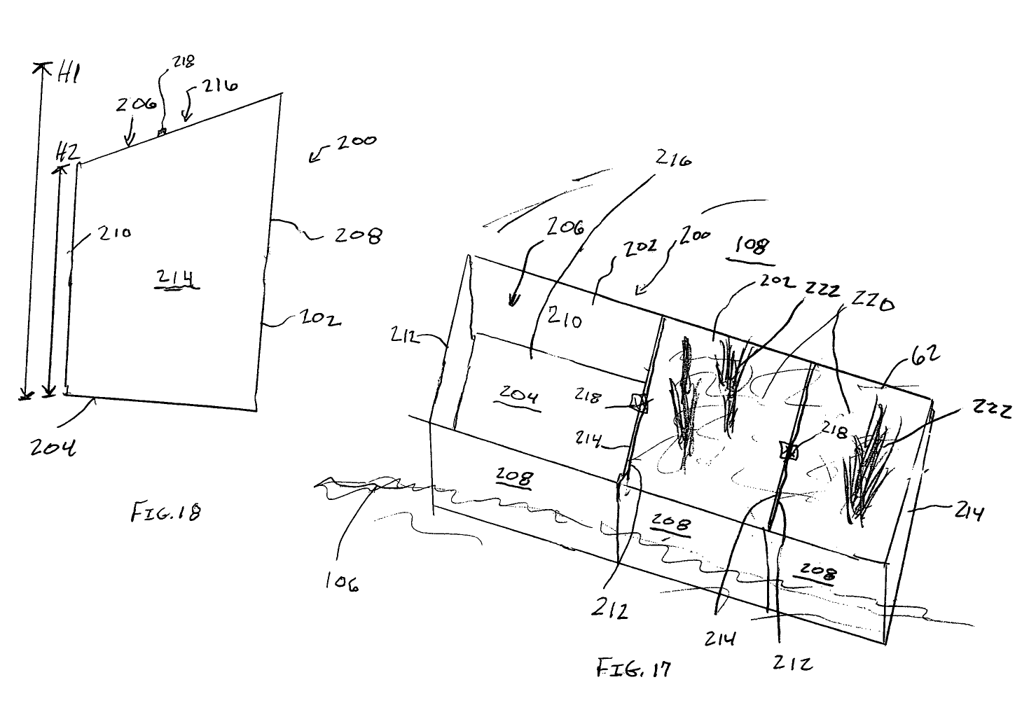

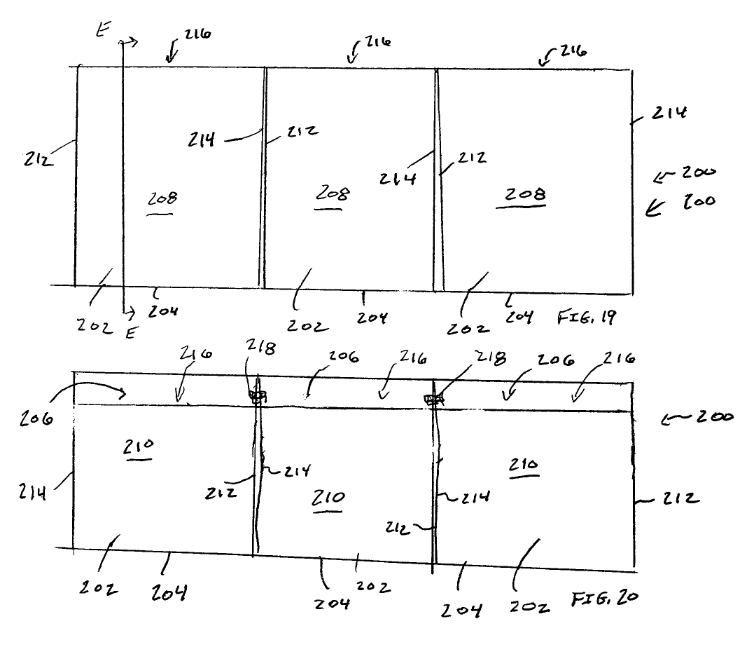

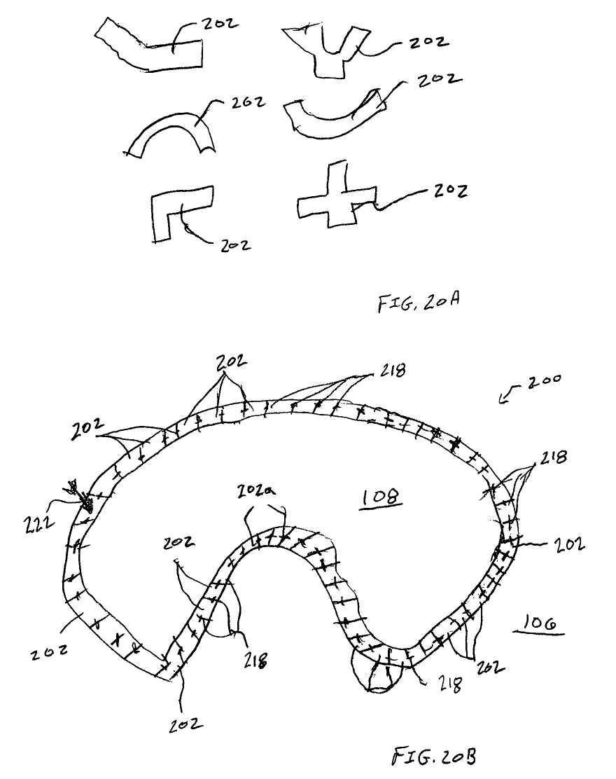

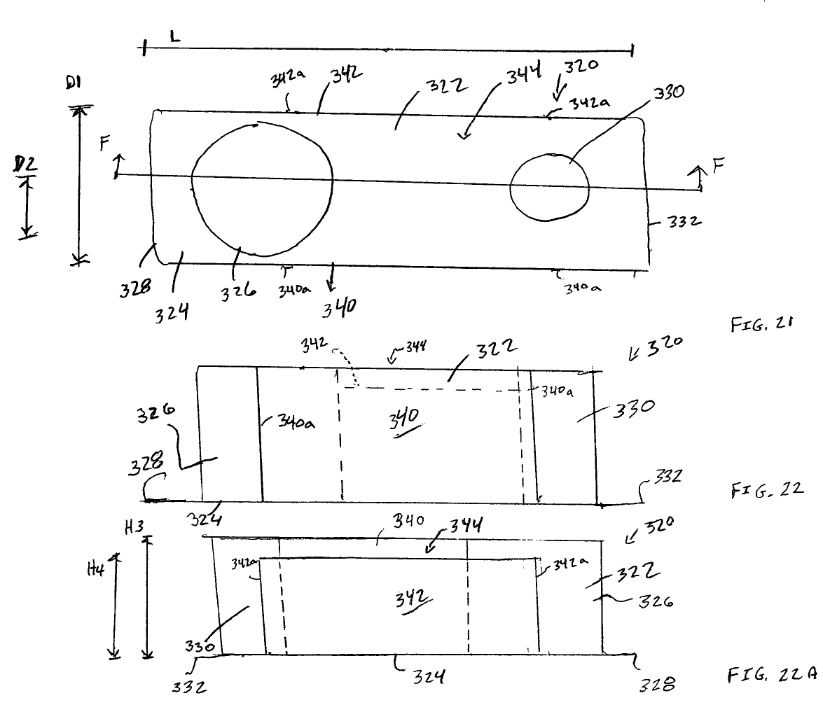

There is also provided a ground flower pot system 200 shown in FIGS. 17-20. There is a ground pot 202 having a ground base 204. The ground pot 202 also has a lawn wall 208, and an opposed garden wall 210 that are joined to the ground base 204. Opposed first and second abutting walls 212, 214, respectively, are joined to the ground base 204, and each extends from the lawn wall 208 to the garden wall 210, and each is joined to the lawn wall 208 and garden wall 210. Opposite the ground base 204 the ground pot 202 has an opening 206. The height of the lawn wall 208, designated H1 in FIG. 18, is greater than the height of the garden wall 210, designated H2 in FIG. 18. In another embodiment (not shown) H2 equals H1 or is greater than H1. Thus, the first and second abutting walls 212, 214, respectfully, decrease in a direction toward the garden wall 210, such that the height H1 of the garden wall 210 is less than a height H2 of the lawn wall 208. A soil recess 216 is thus defined between the base 204, lawn wall 208, garden wall 210, and opposed abutting walls 212, 214, respectively.

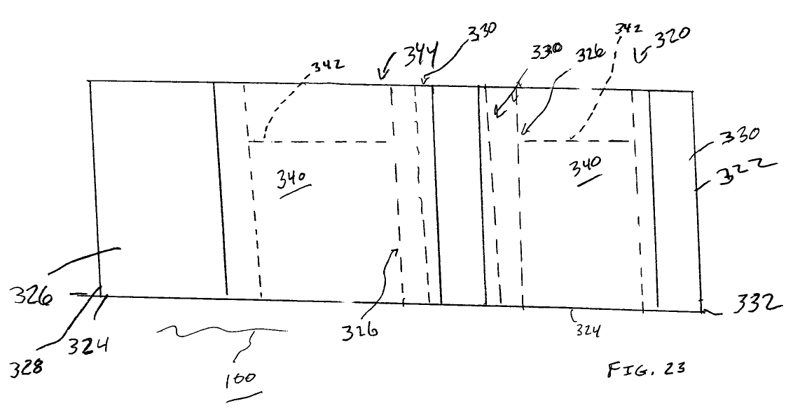

Clips or clamps 218 are provided to clamp a line of the ground pots 202 together, as shown in FIGS. 17, 19 and 20. In other embodiments, the ground pots 202 could include locking devices such that the locking devices and ground pot are one piece and adjacent ground pots 202 are capable of being snapped together. The ground flower pots 202 are positioned around gardens or plants 108 as shown in FIG. 17, flower gardens as shown in FIG. 20B, sidewalks (not shown), etc. Then, the soil recesses 216 are filled with soil 220 and plants 222 are planted in the soil 220, as shown in FIG. 17. Thus, the ground pots system 200 advantageously separates surrounding ground, pavement or concrete 100 or lawn 106, from the garden 108. In other embodiments, as shown in FIGS. 20A and 20B, the ground pots 202 are embodied to have different shapes including, for example, curved, right angled, convex and concave curves, T-shapes, Y-shapes. These shapes advantageously allows the ground pots 202 to be positioned around virtually any shaped garden 108 as shown in FIG. 20B. The ground flower pots 202 can are made from molding plastic into the shape of the plastic by injection molding, blow molding or other suitable molding techniques. Molding plastic well know to those having ordinary skill in the art. The ground pots 202 can also comprise clay, pottery, metal, wood, etc.

There is a method of making the ground pot 202 comprising providing a ground base 204 and joining a lawn wall 208 and an opposed garden wall 210 to the ground base 204. The method includes providing opposed first and second abutting walls 212, 214, respectively, and joining them to the ground base 204 and the opposed lawn and garden walls 208, 210, respectively.

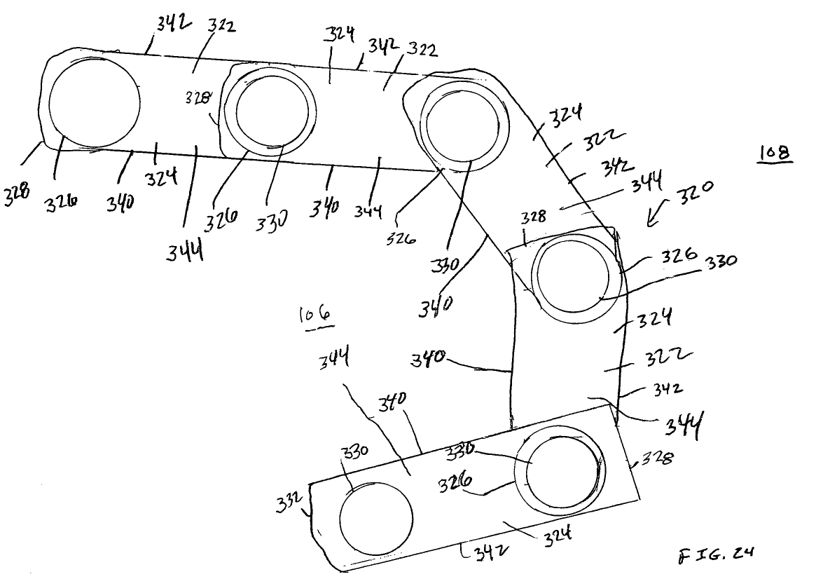

Another embodiment is shown in FIGS. 21-24 for a link flower pot 320 system comprised of flower pot link segments 322 (also referred to herein as link segments 322) that can be linked to one another. As shown in FIGS. 21-22A, each link segment 322 includes a link base 324, a first tube 326 joined to proximal a first end 328 of the link base 324 and a second tube 330 joined proximal to a second end 332 of the link base 324. The first tube 326 has a first diameter designated D1 in FIG. 21, and the second tube 330 has a second diameter designated D2 in FIG. 21. The diameter D2 of the second tube 330 is less than the diameter D1 of the first tube 326. Each link segment 322 further includes a lawn wall 340 joined to the link base 324 and an opposed garden wall 342 joined to the link base 324. It is pointed out that the lawn wall 340 and the garden wall 342 do not extend the complete length, designated L in FIG. 21, of the link base 324. That is, the lawn wall 340 and an opposed garden wall 342 end before reaching the first and second ends 328, 332, respectively, of the link base 324. As shown, the lawn wall 340 and an opposed garden wall 342 extend along the link base a distance such that the opposed lawn wall side edges 340a and the opposed garden wall side edges 342a are adjacent the first and second tubes 326, 330, respectively, as shown in FIGS. 21-22A. This advantageously provides clearance such that when the link segments 322 can be linked together and pivoted relative to one another once linked, as shown in FIG. 24. A linking pot recess 344 is defined that extends from the link base 324, to the first tube 326, to the second tube 330, to the lawn wall 340 and to the garden wall 342. The lawn wall 340 has a greater height, designated H3 in FIG. 22A, than the height, designated H4 in FIG. 22A, of the garden wall 342. In another embodiment (not shown), H4 is equal to or is greater than H3.

To link the flower pot segments 322, a link segment 322 is placed on the ground 100. A second link segment 322 moved over the link segment 322 that is resting on the ground 100 and lowed, such that first tube 326 of the link segment 322 being lower is fitted around the second tube 330 of the link segment 322 that is on the ground, as shown in FIGS. 23 and 24, thus linking the adjacent flower pot segments 322 together. Linked flower pot segments 322 are shown in FIGS. 23 and 24. Thus, because the diameter of the second tube 330 is less than the diameter of the first tube 326, the first tube 326 is capable of being fitted over the second tube 330, to link the flower pot segments 322 together. Additional flower pot segments 322 can be linked together as desired. In addition, the linked flower pot segments 322 can be advantageously easily positioned around plants or gardens 108 and are useable to separated lawn 106 from garden 108 as shown in FIG. 24. In addition, after positioning the flower pot segments 322, the linking pot recesses 344 are filled with soil 220 and plants 222 are planted therein. The flower pot segments comprise plastics, clay and other suitable materials. The flower pot segments 322 are made by molding the plastic into the shape of the link segment 322 by, for example, injection molding. Molding plastic is well known to those having ordinary skill in the art.

There is a method of making the flower pot link segments 322 including providing a link base 324, and joining a first tube 326 proximal a first end 328 of the link base 324, and joining a second tube 330 joined proximal to a second end 332 of the link base 324. The method includes providing the first tube 326 with a first diameter designated D1 in FIG. 21, and providing the second tube 330 with a second diameter designated D2, such that the diameter D2 of the second tube 330 is less than the diameter D1 of the first tube 326. The method includes joining a lawn wall 340 to the link base 324 and joining an opposed garden wall 342 to the link base 324, and defining a linking pot recess 344 that extends from the link base 324, to the first tube 326, to the second tube 330, to the lawn wall 340 and to the garden wall 342.

It will be appreciated by those skilled in the art that while a flower pot, ground flower pot and flower pot segments have been described above in connection with particular embodiments and examples, the invention is not necessarily so limited, and other embodiments, examples, uses, and modifications and departures from the described embodiments, examples, and uses may be made without departing from the flower pot, ground flower pot and flower pot segments. All of these embodiments are intended to be within the scope and spirit of the flower pot, ground flower pot and flower pot segments invention.

What is claimed:

1. A pot comprising:
a surrounding wall having a curved portion and the surrounding wall having a rim defines an opening for receiving a plant,
a base having a flat base portion and the base is joined to a first end of the surrounding wall opposite the rim, and
an internal post support structure joined to the flat base portion and the internal post support structure extends in a direction toward the rim.

2. A pot according to claim 1 wherein the surrounding wall has a flat portion that is joined to the curved portion and wherein the internal post support structure is for receiving a post.

3. The pot according to claim 1 wherein the internal post support structure includes a first internal wall, a second internal wall, a third internal wall and a fourth internal wall each joined to the flat base portion and to one another and extending in a direction away from the flat base portion.

4. The pot according to claim 3 further including a post wall joined to the internal post support structure and wherein the first, second, third and a fourth internal walls define a post opening that that is in communication with a post recess and the post recess is for receiving a post.

5. The pot according to claim 4 wherein the first, second, third and a fourth internal walls slope inwardly.

6. The pot according to claim 4 wherein the first, second, third and a fourth internal walls are each perpendicular to the base flat portion.

7. The pot according to claim 1 wherein the base has flow openings for allowing excess water for escape.

8. The pot according to claim 1 wherein the curved portion has a truncated conical shape.

9. The pot according to claim 1 wherein the flat portion has connector openings for receiving a connector member such that the pot is capable of being supported on a post.

10. A pot and support assembly comprising:
surrounding wall having a curved portion and the surrounding wall having a first end and an opposed second end,
a base having a flat base portion and the base is joined to the first end of the surrounding wall opposite the second end,
an internal post support structure that defines a post recess joined to the flat base portion and extending in a direction toward the second end of the surrounding wall,
a block sized to be received in the block sized to be received in the post recess positioned in the post recess, and
a load member having a ground end for being supported in the ground and an opposed support end that abuts against and supports the block in the internal post recess.

11. The pot and support assembly according to claim 10 wherein the load member has a lateral support joined to it proximal the support end for supporting the block and wherein the lateral support abuts against the block.

12. The pot and support assembly according to claim 11 wherein the block has a block recess for receiving the support end of the load member when supported thereon.

13. The pot and support assembly according to claim 10 wherein the load member is straight.

14. The pot and support assembly according to claim 10 wherein the load member is curved such that it can be joined to a vertical support.

15. A pot and support assembly comprising:
a curved wall having first and second ends and the second end defining an opening for receiving a plant,
a base having a flat base portion and the base is joined to the first end of the surrounding wall, and
an internal support body having a tubular wall joined to the flat base portion and the tubular wall extends in a direction toward the second end of the pot and wherein the tubular wall defines a load support opening that leads to a load support recess defined in the tubular wall, and a load support member having a lateral support and a support end adapted to be received in the load support recess and wherein the load support member has a lateral support that abuts against the flat base portion such that the load support member is capable of supporting the pot when the load support end is positioned in the load support recess.

16. The pot and support assembly according to claim 15 wherein the load support member is curved such that it can be joined to a wall.

17. A ground pot comprising:
a ground base;
a lawn wall and an opposed garden wall joined to the ground base,
opposed abutting walls joined to the ground base and joined to the opposed lawn wall and garden wall and the opposed abutting walls and extend from the lawn wall to the garden wall, and
a recess is defined by the ground base, the opposed abutting walls, and the lawn wall and the garden wall and the recess for receiving a plant.

18. The ground pot according to claim 17 wherein the lawn wall has a height that is greater than a height of the garden wall and a clamp for clamping adjacent ground pots together.

19. A link flower pot comprising:
a link base having a first end and an opposed second end;
a lawn wall and an opposed garden wall each of which is joined to and extends in a direction away from the link base,
a first tube joined to the link base proximal the first end and a second tube joined to the link base proximal the second end and wherein a diameter of the first tube is greater than that of the second tube such that a plurality of flower pot segments are capable of being linked together, and.
wherein the lawn wall has opposed lawn wall edges that extend such that they are proximal the first and second tubes and the garden wall has opposed garden wall edges that extend such that they are proximal the first and second tubes.

20. A method of making a pot comprising:
providing a surrounding wall having a curved portion and providing flat portion and joining the curved portion to the flat portion and providing the surrounding wall with a rim defining an opening for receiving a plant,
providing a base having a flat base portion and joining the base to the surrounding wall opposite the rim, and
providing an internal post support structure and joining the internal post structure to the flat base portion and extending the internal post support structure in a direction toward the rim.
